(19) United States
(12) Patent Application Publication
(10) Pub. No.: US 2022/0207382 A1
(43) Pub. Date: Jun. 30, 2022

(54) APPARATUS AND METHOD FOR REFINING DATA AND IMPROVING PERFORMANCE OF BEHAVIOR RECOGNITION MODEL BY REFLECTING TIME-SERIES CHARACTERISTICS OF BEHAVIOR

(71) Applicant: Electronics and Telecommunications Research Institute, Daejeon (KR)

(72) Inventors: Seung Eun CHUNG, Daejeon (KR); Chi Yoon JEONG, Daejeon (KR); Hyun Tae JEONG, Daejeon (KR); Ga Gue KIM, Daejeon (KR); Kyoung Ju Noh, Daejeon (KR); Jeong Muk LIM, Daejeon (KR); Ji Youn LIM, Daejeon (KR)

(73) Assignee: Electronics and Telecommunications Research Institute, Daejeon (KR)

(21) Appl. No.: 17/538,398

(22) Filed: Nov. 30, 2021

(30) Foreign Application Priority Data
Dec. 28, 2020 (KR) 10-2020-0184950

(51) Int. Cl. G06N 5/02; G06K 9/62; G06N 5/04

(52) U.S. Cl. CPC G06N 5/022; G06N 5/04; G06K 9/6262; G06K 9/6215

(57) ABSTRACT

Provided is an apparatus for refining data and improving the performance of a behavior recognition model by reflecting time-series characteristics of a behavior. The apparatus includes: a data pre-processing unit configured to receive training data and real-time data as input, identify a missing value of sensor data, and interpolate the sensor data; a behavior recognition unit configured to, through a behavior recognition model, generate a behavior recognition classification result for the preprocessed real-time data; a data refinement unit configured to correct the behavior recognition classification result to generate a refined dataset; a learning model update unit configured to analyze a similarity of the refined dataset and, based on a result of the analysis, perform learning to generate the behavior recognition model; and an information output unit configured to express a corrected behavior recognition result to a user.

### CROSS-REFERENCE TO RELATED APPLICATION

This application claims priority to and the benefit of Korean Patent Application No. 10-2020-0184950, filed on Dec. 28, 2020, the disclosures of which is incorporated herein by reference in its entirety.

### BACKGROUND

### 1. Field of the Invention

The present invention relates to an apparatus for refining data and improving the performance of a behavior recognition model by reflecting time-series characteristics of a behavior.

### 2. Discussion of Related Art

For behavior recognition, data is often obtained from user wearable devices. However, because behaviors are diverse in the type, intensity, and activity range and have a large variation between users, even commercial products that may be used in daily life always have a data missing interval due to sensor or measurement errors, and the like

In order to train a behavior recognition model, segment data divided by a certain time unit is used for learning, but when a segment contains a missing value, the corresponding segment may not be utilized, and thus the number of pieces of data available for learning is limited.

Similarly, when a segment input for behavior recognition has a missing value, the corresponding interval may not provide a classification result, and such a behavior recognition result classified in units of segments does not reflect various time-series characteristics of behaviors appearing consecutively in a range of a movement of a human body.

In addition, in order to train a behavior recognition model through deep learning, a label tagged by a user and data matching the label are relied on as a correct answer sheet and training is performed, but the possibility of a human error that occurs due to constraints of various situations cannot be excluded.

### SUMMARY OF THE INVENTION

The present invention is directed to providing an apparatus for refining data and improving performance of a behavior recognition model by reflecting time-series characteristics of behavior that is capable of improving the performance of behavior recognition by interpreting and correcting a classification result to reflect time-series characteristics of a behavior through post-processing

The present invention is directed to providing an apparatus for refining data and improving performance of a behavior recognition model by reflecting time-series characteristics of behavior, in which, when input real-time data has a missing section due to a measurement error, and the like, sample data having a high similarity is extracted from a database for representative pattern sample data, and the missing value is inferred, and interpolation is performed on the basis of the sample data.

The present invention is directed to providing an apparatus for refining data and improving performance of a behavior recognition model by reflecting time-series characteristics of behavior that is capable of reflecting a combination of various time series characteristics of behaviors, including not only the periodicity of behaviors but also the constraint of the order of transition between behaviors (the sequentiality) and the causal necessity of transition between behaviors, and the transition time between behaviors taking into account the reaction speed of a human body and the duration of a behavior (the continuity) to refine data used for behavior recognition so that the performance of a behavior recognition learning model may be improved.

The technical objectives of the present invention are not limited to the above, and other objectives may become apparent to those of ordinary skill in the art based on the following description.

According to an aspect of the present invention, there is provided an apparatus for refining data and improving a performance of a behavior recognition model by reflecting time-series characteristics of a behavior, the apparatus including: a data pre-processing unit configured to receive training data and real-time data as input, identify a missing value of sensor data, and interpolate the sensor data; a behavior recognition unit configured to, through a behavior recognition model, generate a behavior recognition classification result for the preprocessed real-time data; a data refinement unit configured to correct the behavior recognition classification result to generate a refined dataset; a learning model update unit configured to analyze a similarity of the refined dataset and, based on a result of the analysis, perform learning to generate the behavior recognition model; and an information output unit configured to express a corrected behavior recognition result to a user.

The data pre-processing unit may include: a data receiving unit configured to receive the training data and the real-time data used for behavior recognition from various sensors; a missingness identification unit configured to identify whether an error or missing value exists in the received real-time data; a data interpolation unit configured to, when it is identified by the missingness identification unit that newly input real-time data needs to be corrected, search for samples having a pattern similar to a pattern of the input real-time data in a database for sample data, infer and generate a value corresponding to an error or missing value of the input real-time data on the basis of sample data having a highest similarity, and interpolate the input real-time data using the generated value.

The sensor may include one or more of an accelerometer sensor, a gyroscope sensor, a geomagnetic sensor, an electrocardiogram sensor, a heart rate sensor, a respiration sensor, a skin temperature sensor, and a skin conductivity sensor.

The data pre-processing unit may be configured to, for use in pre-processing, manage a database for representative pattern sample data including samples of various representative values matching a behavior targeted for recognition among datasets having been used for training the behavior recognition model.

The data pre-processing unit may be configured to, in response to a behavior that is repeatedly observed in training datasets or identified to be eligible to have a meaning in addition to the behavior targeted for recognition, add data corresponding to the behavior to the database for the representative pattern sample data and manage the database.

The data pre-processing unit may be configured to: when data having been used for the learning includes various users or sensors, manage generalized or general-purpose representative pattern data in a database and, when data having been used for the learning includes data from a specific user or specific sensor, manage personalized or dedicated representative pattern data in a database.

The behavior recognition unit may further include a recognition model synchronization unit configured to train the behavior recognition model using the training data including a behavior label (a correct answer sheet) and a sensor dataset corresponding to the behavior label, and the behavior recognition unit may be repeatedly updated using information about the behavior recognition model received from the learning model update unit later so as to be kept synchronized with latest information.

The data refinement unit may correct the behavior recognition result to generate a refined data set. The data refinement unit may include a recognition result correction unit, a refined data set generation unit, and a representative pattern data generation unit.

The recognition result correction unit may be configured to correct a result of the behavior recognition model by reflecting time-series characteristics of a behavior that appears consecutively in a range of a movement of a human body.

The refined data set generation unit may be configured to divide the sensor data corresponding to a corrected recognition result (a label) to generate the refined dataset including a pair of [label, sensor data].

The representative pattern data generation unit may be configured to generate representative pattern data identified as a representative value of the behavior in the refined dataset and store the representative pattern data in a database for representative pattern sample data.

The time-series characteristics of the behavior may include one of: a constraint of an order of transition between behaviors (sequentiality of behaviors) and a causal necessity of transition between behaviors; a transition time between behaviors taking into account a reaction time of a human body and a duration of a behavior (continuity of a behavior); and a movement having a chance of repetitively occurring (periodicity of a behavior).

The learning model update unit may include: a dataset similarity analysis unit configured to analyze a similarity of a dataset used for learning; and a behavior recognition model generator configured to analyze a similarity of a dataset and, on the basis of the result of the analysis, perform learning to generate the behavior recognition model. The behavior recognition model may be configured to, through learning and optimization being performed with a new refined dataset, have various parameters (a weight, a bias, etc.), a layer having a learnable parameter (a convolutional layer, a linear layer, etc.), a value of a registered buffer, and an optimizer and hyperparameter thereof changed to reflect the new refined dataset.

The learning model update unit may perform the learning only when a similarity between a dataset having previously been used and the refined dataset is less than or equal to a threshold.

The learning model update unit may repeat a process of synchronizing with the behavior recognition model of the behavior recognition unit until the similarity between the datasets converges.

According to an aspect of the present invention, there is provided a method of refining data and improving a performance of a behavior recognition model by reflecting time-series characteristics of a behavior, the method including: by a data pre-processing unit, receiving training data, identifying a missing value of sensor data, and interpolating the sensor data; by a behavior recognition unit, generating a behavior recognition classification result through a behavior recognition model; by a data refinement unit, correcting the behavior recognition classification result to generate a refined dataset; and by a learning model update unit, analyzing a similarity of a dataset and, based on a result of the analysis, performing learning to generate the behavior recognition model.

The generating of the behavior recognition model may include repeating a process of synchronizing with the behavior recognition model of the behavior recognition unit until the similarity between the datasets converges.

The generating of the behavior recognition model may include: in the analyzing of the similarity of the dataset, receiving a newly generated refined dataset as input and analyzing the similarity on the basis of a dataset having previously been used; and when the similarity is less than or equal to a threshold, returning the refined dataset received as input so that the refined dataset is used for recognition model training.

The generating of the behavior recognition model may include additionally using training data having not been used for learning to verify a performance of the behavior recognition model.

According to an aspect of the present invention, there is provided a method of refining data and classifying a behavior recognition model by reflecting time-series characteristics of a behavior, the method including: by a data pre-processing unit, receiving sensor data that is input in real-time, identifying a missing value of the received sensor data, and interpolating the received sensor data; by a behavior recognition unit, generating a behavior recognition classification result through a behavior recognition model; and by a data refinement unit, correcting a corresponding recognition result; and by an information output unit, expressing the corrected corresponding recognition result.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram for describing an apparatus for refining data and improving the performance of a behavior recognition model by reflecting time-series characteristics of a behavior according to an embodiment of the present invention;

FIG. 2 is a block diagram for describing a detailed configuration of a data processing unit of FIG. 1;

FIG. 3 is a block diagram for describing a detailed configuration of a behavior processing unit of FIG. 1;

FIG. 4 is a block diagram for describing a detailed configuration of a data refinement unit of FIG. 1;

FIG. 5 is a reference diagram for describing a learning process in the apparatus for refining data and improving a performance of a behavior recognition model by reflecting time-series characteristics of a behavior according to the embodiment of the present invention;

FIG. 6 is a flowchart for describing a learning method in a method of refining data and improving a performance of a behavior recognition model by reflecting time-series characteristics of a behavior according to an embodiment of the present invention;

FIG. 7 is a reference diagram for describing a classification system for providing a method of refining data and improving a performance of a behavior recognition model by reflecting time-series characteristics of a behavior according to an embodiment of the present invention; and

FIG. 8 is a flowchart for describing a classification method in a method of refining data and improving a performance of a behavior recognition model by reflecting time-series characteristics of a behavior according to an embodiment of the present invention.

### DETAILED DESCRIPTION OF EXEMPLARY EMBODIMENTS

Advantages and features of the present invention and methods for achieving them will be made clear from embodiments described in detail below with reference to the accompanying drawings. However, the present invention may be embodied in many different forms and should not be construed as being limited to the embodiments set forth herein. Rather, these embodiments are provided so that this disclosure will be thorough and complete and will fully convey the scope of the present invention to those of ordinary skill in the technical field to which the present invention pertains. The present invention is defined by the claims. Meanwhile, terms used herein are for the purpose of describing the embodiments and are not intended to limit the present invention. As used herein, the singular forms include the plural forms as well unless the context clearly indicates otherwise. The term “comprise” or “comprising” used herein does not preclude the presence or addition of one or more other elements, steps, operations, and/or devices other than stated elements, steps, operations, and/or devices.

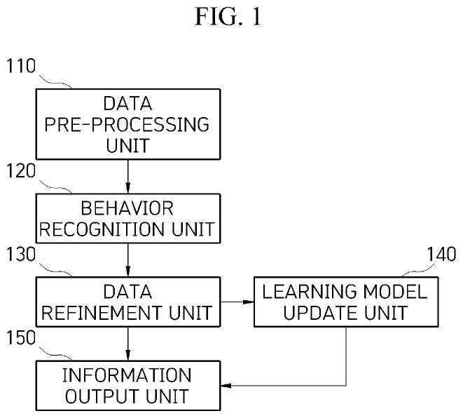

FIG. 1 is a block diagram for describing an apparatus for refining data and improving a performance of a behavior recognition model by reflecting time-series characteristics of a behavior according to an embodiment of the present invention.

Referring to FIG. 1, the apparatus for refining data and improving a performance of a behavior recognition model by reflecting time-series characteristics of a behavior according to the embodiment of the present invention includes a data pre-processing unit 110, a behavior recognition unit 120, a data refinement unit 130, a learning model update unit 140, and an information output unit 150.

The data pre-processing unit 110 receives training data used for training a behavior recognition model and real-time data used for behavior recognition from various sensors. A sensor refers to all types of sensors that respond to or are affected by a user's behavior, and includes various sensors, such as an accelerometer sensor, a gyroscope sensor, a geomagnetic field sensor, an electrocardiogram sensor, a heart rate sensor, a respiration sensor, a skin temperature sensor, a skin conductivity sensor, etc.

In addition, the data pre-processing unit 110 identifies whether an error or missing value exists in the received real-time data and corrects the data.

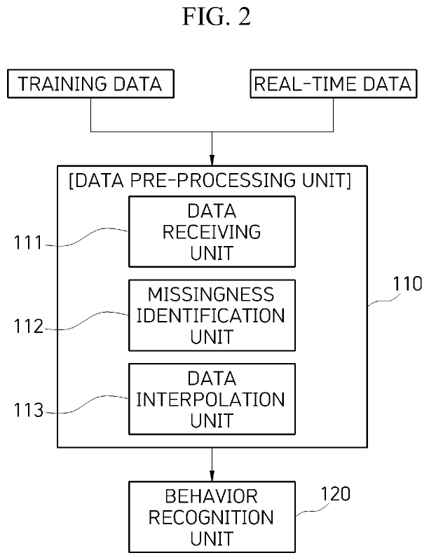

FIG. 2 is a block diagram for describing a detailed configuration of a data processing unit of FIG. 1.

Referring to FIG. 2, the data pre-processing unit 110 includes a data receiving unit 111, a missingness identification unit 112, and a data interpolation unit 113.

The data receiving unit 111 receives training data and real-time data used for behavior recognition from various sensors.

In addition, the missingness identification unit 112 identifies whether an error or a missing value exists in the received real-time data.

The data interpolation unit 113 may be configured to, when it is identified by the missingness identification unit 112 that newly input real-time data needs to be corrected, search for samples having a pattern similar to a pattern of the input real-time data in a database for sample data, and infer and generate a value corresponding to an error or missing value of the input real-time data on the basis of sample data having the highest similarity and interpolate the input real-time data using the generated value.

The data pre-processing unit 110 is configured to, for use in pre-processing, manage a database for representative pattern sample data including samples of various representative values matching a behavior targeted for recognition among datasets having been used for training the behavior recognition model. The data pre-processing unit 110, in response to a behavior that is repeatedly observed in training datasets or identified to be eligible for having a meaning in addition to the behavior targeted for recognition, adds data corresponding to the behavior to the database for the representative pattern sample data and manages the database.

The data pre-processing unit 110, when data having been used for the learning includes various users or sensors, manages generalized or general-purpose representative pattern data in a database, and when data having been used for the learning includes data from a specific user or specific sensor, manages personalized or dedicated representative pattern data in a database.

The data pre-processing unit 110 transmits the input real-time data pre-processed by interpolation to the behavior recognition unit 120.

The behavior recognition unit 120 receives the pre-processed real-time data as input and derives a classification result of behavior recognition through the behavior recognition model. Here, the behavior recognition model is a model generated by learning using training data that includes a behavior label (a correct answer sheet) and a sensor dataset corresponding thereto and is repeatedly updated using information about the behavior recognition model received from the learning model update unit 140 at a later time and kept synchronized with the latest information.

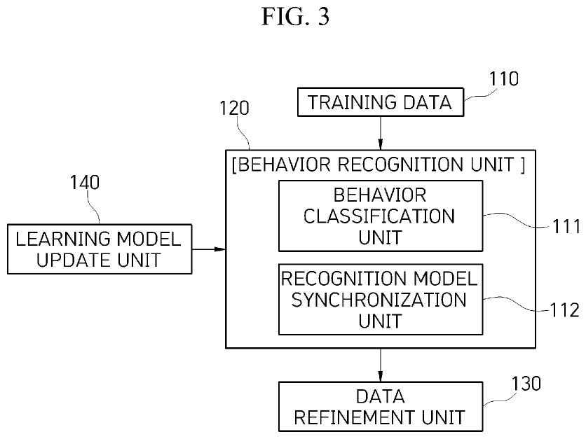

FIG. 3 is a block diagram for describing a detailed configuration of a behavior processing unit of FIG. 1.

As shown in FIG. 3, the behavior recognition unit 120 includes a behavior classification unit 121 and a recognition model synchronization unit 122.

The behavior classification unit 121 generates a behavior recognition classification result through the trained behavior recognition model.

The recognition model synchronization unit 122 trains the behavior recognition model using training data including a behavior label (a correct answer sheet) and a sensor dataset corresponding thereto. In this case, the recognition model synchronization unit 122 is repeatedly updated using information about the behavior recognition model received from the learning model update unit 140 at a later time, and kept synchronized with latest information.

The result of the behavior recognition model received from the behavior recognition unit 120 is corrected by reflecting a combination of time-series characteristics of a behavior that appears consecutively in a range of movement of a human body. The time-series characteristics of the behavior include characteristics of various aspects, such as: a constraint of an order of transition between behaviors (sequentiality of behaviors) and a causal necessity of transition between behaviors; a transition time between behaviors taking into account a reaction time of a human body and a duration of a behavior (continuity of a behavior); and a movement having a chance of repetitively occurring (periodicity of a behavior).

For example, in order for a person to go from being lying down to walking, the person needs to perform a behavior of standing up. Based on the sequentiality and causal necessity of the behaviors, when a “lying down” behavior is recognized at time t and a “walking” behavior is recognized at time t+2, it may be inferred that a behavior at time t+1 should be a “standing up” behavior.

As another example, it may be assumed that a “lying down” behavior is recognized at time t and a “lying down” behavior is recognized at time t+2. When a unit time for recognition is 0.1 seconds, it may be inferred that a behavior at time t+1 is also “lying down”, considering the reaction time of a human body and the continuity of a behavior.

Finally, as for a movement that may repetitively occur, such as “going up and down stairs” and “using dishes during meals”, it may be inferred that the same behaviors occur in a certain period between a start time and an end time of the behavior based on the periodicity of the behavior.

The result of the behavior recognition model corrected based on the time-series characteristics of the behavior is transmitted to the information output unit 150 so that the result of behavior recognition may be used by a user or another program or application.

In addition, the data refinement unit 130 divides sensor data corresponding to the corrected recognition result (a label) to generate a refined dataset including a pair of [label, sensor data], and the refined dataset is transmitted to the learning model update unit 140 and used to train a behavior recognition model.

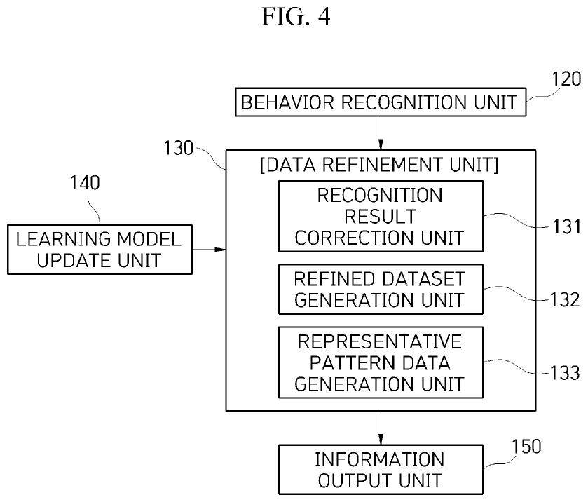

The data refinement unit 130 corrects the behavior recognition result to generate the refined dataset. As shown in FIG. 4, the data refinement unit 130 includes a recognition result correction unit 131, a refined dataset generation unit 132, and a representative pattern data generation unit 133.

As shown in FIG. 4, the recognition result correction unit 131 corrects the result of the behavior recognition model by reflecting time-series characteristics of a behavior consecutively appearing in a range of a movement of a human body.

Then, the refined dataset generation unit 132 divides sensor data corresponding to the corrected recognition result (a label) to generate a refined dataset including a pair [label, sensor data]

In addition, the representative pattern data generation unit 133 generates representative pattern data that is identified as a representative value of the behavior in the refined dataset and stores the representative pattern data in a database for representative pattern sample data.

The learning model update unit 140 trains the behavior recognition model using the refined dataset received from the data refinement unit 130. In principle, the behavior recognition model of the learning model update unit 140 basically shares the same structure as the behavior recognition model of the behavior recognition unit 120 but is configured to, through learning and optimization being performed with a new refined dataset, have various parameters (e.g., a weight, a bias, etc.), a layer having a learnable parameter (e.g., a convolutional layer, a linear layer, etc.), a value of a registered buffer, and an optimizer and hyperparameter thereof changed to reflect the new refined dataset.

Information about the behavior recognition model generated as described above is transmitted to the behavior recognition model of the behavior recognition unit 120, and through such information being repeatedly updated, the behavior recognition model may be kept synchronized with the latest information.

The learning model update unit 140 analyzes the similarity of a dataset used for learning and performs learning only when the similarity between a dataset having previously been used and the refined dataset is less than or equal to a threshold.

When the refined dataset generated by the correction of the recognition result is not significantly different from the existing dataset, re-learning is prevented from being performed so that a waste of resources may be prevented.

Such a re-learning process is repeatedly performed until it is identified that the similarity between the datasets converges so that the performance of the behavior recognition model may be improved.

The information output unit 150 expresses the corrected result of behavior recognition to the user or transmits the information so that the information is used in another program or application.

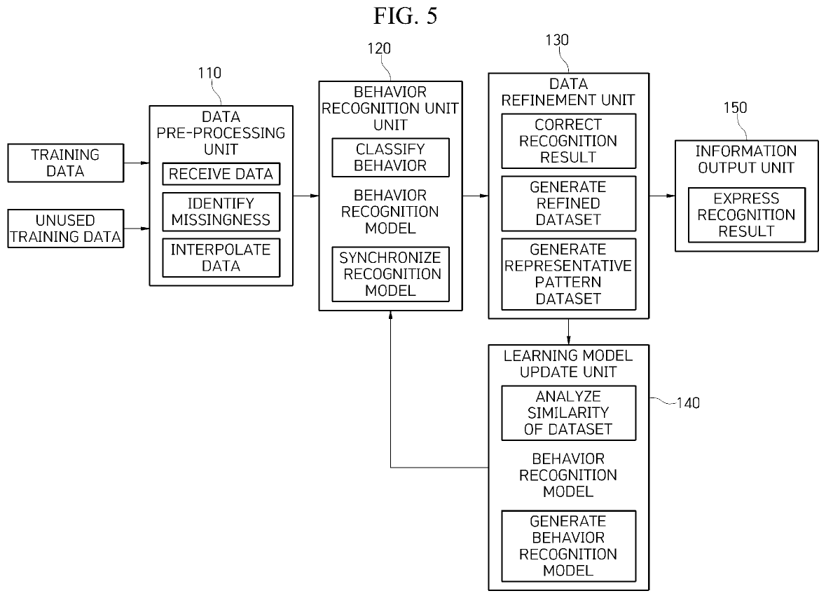

FIG. 5 is a reference diagram for describing a learning process in the apparatus for refining data and improving a performance of a behavior recognition model by reflecting time-series characteristics of a behavior according to the embodiment of the present invention.

As shown in FIG. 5, in a learning process by the apparatus for refining data and improving a performance of a behavior recognition model by reflecting time-series characteristics of a behavior, the data pre-processing unit 110, based on training data being received as input, identifies a missing value of sensor data and interpolates the sensor data, and the behavior recognition unit 120 generates a behavior recognition classification result through a behavior recognition model. Then, the data refinement unit 130 corrects the corresponding behavior recognition result to generate a refined dataset. The learning model update unit 140 analyzes the similarity between datasets and, based on the result of the analysis, performs learning to generate a behavior recognition model and, in this regard, repeats a process of synchronizing with the behavior recognition model of the behavior recognition unit 120 until the similarity between the datasets converges.

On the other hand, the analysis of the dataset similarity includes receiving a newly generated refined dataset as input to analyze the similarity on the basis of a dataset having previously been used, and when the similarity is less than or equal to a threshold, returning the refined dataset received as input so that the refined dataset is used to train the recognition model. The performance of the behavior recognition model may be additionally verified using training data having not been used for learning, or overfitting of the model may be prevented and high performance may be obtained even for new data not shown in learning by tuning various parameters having been used in the model. As needed, the recognition result may be expressed through the information output unit.

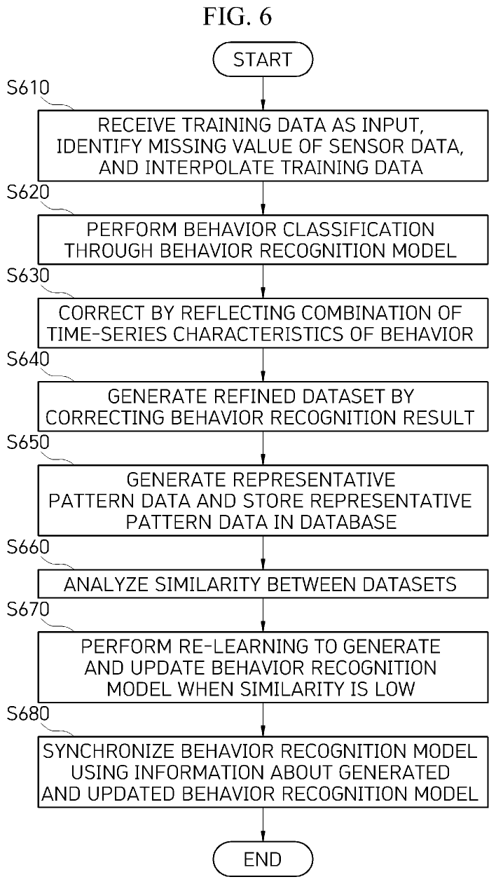

Hereinafter, a learning method in a method of refining data and improving a performance of a behavior recognition model by reflecting time-series characteristics of a behavior according to an embodiment of the present invention will be described with reference to FIG. 6.

First, training data is received by the data pre-processing unit, and a missing value of sensor data is identified and the sensor data is interpolated by the data pre-processing unit (S610).

In an operation of generating a behavior recognition classification result (S620), a behavior classification is performed through a behavior recognition model (S620).

The recognition result is corrected by reflecting a combination of time-series characteristics of the behavior (S630).

Thereafter, a refined dataset is generated by correcting the behavior recognition result by the data refinement unit (S640).

In this case, representative pattern data identified as a representative value of the behavior in the refined dataset is generated and stored in a database (S650).

Next, the similarity between a dataset having previously been used for learning and the refined dataset is analyzed by the learning model update unit (S660)

Only when the similarity is low, is re-learning performed to generate and update the behavior recognition model (S670).

In the operation of the behavior recognition model (S670), a process of synchronizing with the behavior recognition model of the behavior recognition unit is repeated until the similarity of the datasets converges.

In the operation of generating the behavior recognition model (S670), the analysis of the dataset similarity includes receiving a newly generated refined dataset as input to analyze the similarity on the basis of a dataset having previously been used, and when the similarity is less than or equal to a threshold, returning the refined dataset received as input so that the refined dataset is used to train the recognition model.

In the operation of generating the behavior recognition model (S670), the performance of the behavior recognition model is verified additionally using training data having not been used for learning, or overfitting of the model may be prevented and high performance may be obtained even for new data not shown in learning by tuning various parameters having been used in the model. As needed, the recognition result may be expressed through the information output unit.

The behavior recognition model may be synchronized using information about the generated and updated behavior recognition model (S680).

According to an embodiment of the present invention, a behavior recognition model is trained and a behavior recognition classification result is corrected by reflecting various time-series characteristics of a behavior that consecutively appear in the range of movement of a human body in training data so that the performance of the behavior recognition can be improved.

In addition, according to an embodiment of the present invention, a database for representative pattern sample data extracted by reflecting behavioral characteristics is maintained to correct an error or missing value that may exist in newly input data due to a sensor error and used for behavior recognition so that the recognition performance can be prevented from being lowered due to input data errors.

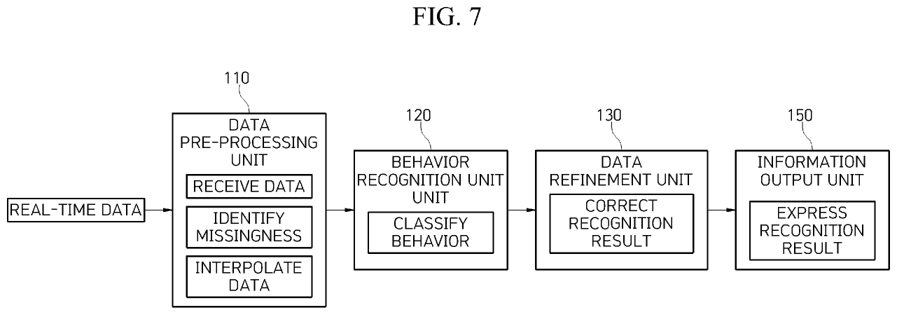

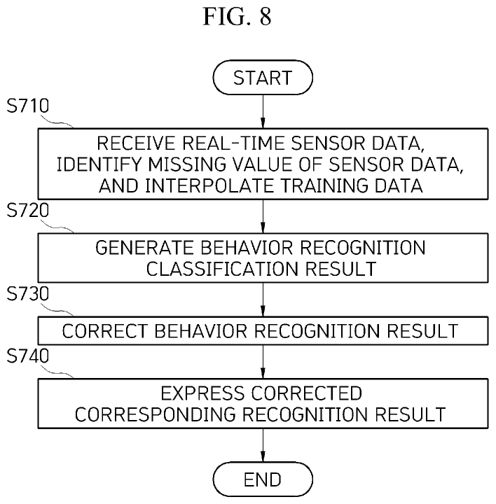

Hereinafter, a classification method in a method of refining data and improving a performance of a behavior recognition model by reflecting time-series characteristics of a behavior according to an embodiment of the present invention will be described with reference to FIGS. 7 and 8.

Sensor data that is input in real-time is received by the data pre-processing unit, and a missing value of the received sensor data is identified and the sensor data is interpolated by the data pre-processing unit (S710).

A behavior recognition classification result is generated by the behavior recognition unit through the behavior recognition model (S720).

The generated behavior recognition result is corrected by the data refinement unit (S730).

The corrected corresponding recognition result is expressed by the information output unit (S740).

As is apparent from the above, according to an embodiment of the present invention, a behavior recognition model is trained and a behavior recognition classification result is corrected by reflecting various time-series characteristics of a behavior that consecutively appear in the range of a movement of a human body in training data so that the performance of the behavior recognition can be improved.

In addition, according to an embodiment of the present invention, a database for representative pattern sample data extracted by reflecting behavioral characteristics is maintained to correct an error or missing value that may exist in newly input data due to a sensor error and used for behavior recognition so that the recognition performance can be prevented from being lowered due to input data errors.

Each step included in the learning method described above may be implemented as a software module, a hardware module, or a combination thereof, which is executed by a computing device.

Also, an element for performing each step may be respectively implemented as first to two operational logics of a processor.

The software module may be provided in RAM, flash memory, ROM, erasable programmable read only memory (EPROM), electrical erasable programmable read only memory (EEPROM), a register, a hard disk, an attachable/detachable disk, or a storage medium (i.e., a memory and/or a storage) such as CD-ROM.

An exemplary storage medium may be coupled to the processor, and the processor may read out information from the storage medium and may write information in the storage medium. In other embodiments, the storage medium may be provided as one body with the processor.

The processor and the storage medium may be provided in application specific integrated circuit (ASIC). The ASIC may be provided in a user terminal. In other embodiments, the processor and the storage medium may be provided as individual components in a user terminal.

Exemplary methods according to embodiments may be expressed as a series of operation for clarity of description, but such a step does not limit a sequence in which operations are performed. Depending on the case, steps may be performed simultaneously or in different sequences.

In order to implement a method according to embodiments, a disclosed step may additionally include another step, include steps other than some steps, or include another additional step other than some steps.

Various embodiments of the present disclosure do not list all available combinations but are for describing a representative aspect of the present disclosure, and descriptions of various embodiments may be applied independently or may be applied through a combination of two or more.

Moreover, various embodiments of the present disclosure may be implemented with hardware, firmware, software, or a combination thereof. In a case where various embodiments of the present disclosure are implemented with hardware, various embodiments of the present disclosure may be implemented with one or more application specific integrated circuits (ASICs), digital signal processors (DSPs), digital signal processing devices (DSPDs), programmable logic devices (PLDs), field programmable gate arrays (FPGAs), general processors, controllers, microcontrollers, or microprocessors.

The scope of the present disclosure may include software or machine-executable instructions (for example, an operation system (OS), applications, firmware, programs, etc.), which enable operations of a method according to various embodiments to be executed in a device or a computer, and a non-transitory computer-readable medium capable of being executed in a device or a computer each storing the software or the instructions.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

Although the present invention has been described in detail above with reference to the exemplary embodiments, those of ordinary skill in the technical field to which the present invention pertains should be able to understand that various modifications and alterations can be made without departing from the technical spirit or essential features of the present invention. Therefore, it should be understood that the scope of the present invention is defined not by the above description but by the following claims.

What is claimed is:

1. An apparatus for refining data and improving a performance of a behavior recognition model by reflecting time-series characteristics of a behavior, the apparatus comprising:
a data pre-processing unit configured to receive training data and real-time data as input, identify a missing value of sensor data, and interpolate the sensor data;
a behavior recognition unit configured to, through a behavior recognition model, generate a behavior recognition classification result for the preprocessed real-time data;
a data refinement unit configured to correct the behavior recognition classification result to generate a refined dataset;
a learning model update unit configured to analyze a similarity of the refined dataset and, based on a result of the analysis, perform learning to generate the behavior recognition model; and
an information output unit configured to express a corrected behavior recognition result to a user.

2. The apparatus of claim 1, wherein the data pre-processing unit comprises:
a data receiving unit configured to receive the training data and the real-time data used for behavior recognition from various sensors;
a missingness identification unit configured to identify whether an error or missing value exists in the received real-time data; and
a data interpolation unit configured to, when it is identified by the missingness identification unit that newly input real-time data needs to be corrected, search for samples having a pattern similar to a pattern of the input real-time data in a database for sample data, infer and generate a value corresponding to an error or missing value of the input real-time data on the basis of sample data having a highest similarity, and interpolate the input real-time data using the generated value.

3. The apparatus of claim 2, wherein the sensor includes one or more of an accelerometer sensor, a gyroscope sensor, a geomagnetic sensor, an electrocardiogram sensor, a heart rate sensor, a respiration sensor, a skin temperature sensor, and a skin conductivity sensor.

4. The apparatus of claim 1, wherein the data pre-processing unit is configured to, for use in pre-processing, manage a database for representative pattern sample data including samples of various representative values matching a behavior targeted for recognition among datasets having been used for training the behavior recognition model.

5. The apparatus of claim 4, wherein the data pre-processing unit is configured to, in response to a behavior that is repeatedly observed in training datasets or identified to be eligible to have a meaning in addition to the behavior targeted for recognition, add data corresponding to the behavior to the database for the representative pattern sample data and manage the database.

6. The apparatus of claim 4, wherein the data pre-processing unit is configured to:
when data having been used for the learning includes various users or sensors, manage generalized or general-purpose representative pattern data in a database; and
when data having been used for the learning includes data from a specific user or specific sensor, manage personalized or dedicated representative pattern data in a database.

7. The apparatus of claim 1, wherein the behavior recognition unit further includes a recognition model synchronization unit configured to train the behavior recognition model using the training data including a behavior label (a correct answer sheet) and a sensor dataset corresponding to the behavior label, and
the behavior recognition unit is repeatedly updated using information about the behavior recognition model received from the learning model update unit later so as to be kept synchronized with latest information.

8. The apparatus of claim 1, wherein the data refinement unit includes:
a recognition result correction unit configured to correct a result of the behavior recognition model by reflecting time-series characteristics of a behavior that appears consecutively in a range of a movement of a human body; and
a refined data set generation unit configured to divide the sensor data corresponding to a corrected recognition result (a label) to generate the refined dataset including a pair of [label, sensor data]; and
a representative pattern data generation unit configured to generate representative pattern data identified as a representative value of the behavior in the refined dataset and store the representative pattern data in a database for representative pattern sample data.

9. The apparatus of claim 8, wherein the time-series characteristics of the behavior includes one of: a constraint of an order of transition between behaviors (sequentiality of behaviors) and a causal necessity of transition between behaviors; a transition time between behaviors taking into account a reaction time of a human body and a duration of a behavior (continuity of a behavior); and a movement having a chance of repetitively occurring (periodicity of a behavior).

10. The apparatus of claim 1, wherein the learning model update unit includes:
a dataset similarity analysis unit configured to analyze a similarity of a dataset used for learning; and
a behavior recognition model generator configured to analyze a similarity of a dataset and, on the basis of the result of the analysis, perform learning to generate the behavior recognition model.

11. The apparatus of claim 1, wherein the behavior recognition model is configured to, through learning and optimization being performed with a new refined dataset, have various parameters (a weight, a bias, etc.), a layer having a learnable parameter (a convolutional layer, a linear layer, etc.), a value of a registered buffer, and an optimizer and hyperparameter thereof changed to reflect the new refined dataset.

12. The apparatus of claim 11, wherein the learning model update unit performs the learning only when a similarity between a dataset having previously been used and the refined dataset is less than or equal to a threshold.

13. The apparatus of claim 1, wherein the learning model update unit repeats a process of synchronizing with the behavior recognition model of the behavior recognition unit until the similarity between the datasets converges.

14. A method of refining data and improving a performance of a behavior recognition model by reflecting time-series characteristics of a behavior, the method comprising:
by a data pre-processing unit, receiving training data, identifying a missing value of sensor data, and interpolating the sensor data;
by a behavior recognition unit, generating a behavior recognition classification result through a behavior recognition model;
by a data refinement unit, correcting the behavior recognition classification result to generate a refined dataset; and
by a learning model update unit, analyzing a similarity of a dataset and, based on a result of the analysis, performing learning to generate the behavior recognition model.

15. The method of claim 14, wherein the generating of the behavior recognition model includes
repeating a process of synchronizing with the behavior recognition model of the behavior recognition unit until the similarity between the datasets converges.

16. The method of claim 14, wherein the generating of the behavior recognition model includes:
in the analyzing of the similarity of the dataset, receiving a newly generated refined dataset as input and analyzing the similarity on the basis of a dataset having previously been used; and
when the similarity is less than or equal to a threshold, returning the refined dataset received as input so that the refined dataset is used for recognition model training.

17. The method of claim 16, wherein the generating of the behavior recognition model includes:
additionally using training data having not been used for learning to verify a performance of the behavior recognition model; or
tuning various parameters having been used in the model to prevent overfitting of behavior recognition model; and
obtaining high performance even for new data not shown in learning.

18. A method of refining data and classifying a behavior recognition model by reflecting time-series characteristics of a behavior, the method comprising:
by a data pre-processing unit, receiving sensor data that is input in real-time, identifying a missing value of the received sensor data and interpolating the received sensor data;
by a behavior recognition unit, generating a behavior recognition classification result through a behavior recognition model; and
by a data refinement unit, correcting a corresponding recognition result; and
by an information output unit, expressing the corrected corresponding recognition result.
